(19) United States
(12) Patent Application Publication
(10) Pub. No.: US 2005/0073199 A1
(43) Pub. Date: Apr. 7, 2005

(54) Swithcing assembly and method

(76) Inventor: William Stephen Jenkin, Holt (AU)

Correspondence Address: William Stephen Jenkin, P O Box 48, Kippax, ACT 2615, AU

(21) Appl. No.: 10/483,333

(22) PCT Filed: Jun. 28, 2002
(86) PCT No.: PCT/AU02/00864

(30) Foreign Application Priority Data
Jul. 10, 2001 (AU) PR 6267

(51) Int. Cl. H02J 1/00

(52) U.S. Cl. 307/38

(57) ABSTRACT

A method of switching electrical equipment between power supplies external to the equipment and a switching assembly is disclosed which includes: connecting first electrical connector means to the electrical equipment; connecting second electrical connector means to a first electrical power supply; providing third electrical connector means for electrical connection to a second electrical power supply, and operating switching means to electrically disconnect the first electrical connector means and the second electrical connector means and to electrically connect the fust electrical connector means and the third electrical connector means; the first, second and third electrical connector means and the switching means being included in the switching assembly.

### TECHNICAL FIELD

This invention relates to a switching assembly and method.

The invention has particular but not exclusive application to a method and apparatus to change-over the power supply of a working electrical device without interrupting its operation. The invention has particular application for an electronic device, such as a computer or networking device, where the device is to be connected to a different power outlet without interrupting the normal operation of the equipment.

For illustrative purposes the present invention will be described with reference to re-connecting a computer from the normal electricity supply to a ‘UPS ’(Uninterruptible Power Supply).

### GLOSSARY

The following acronyms, abbreviations and terms are used throughout the specification:
UPS—Uninterruptible Power Supply
IEC—International Electrical Connector
SAA—Standards Authority Australia
Power supply—A source of electrical power, such as normal commercial reticulated 240V AC, a generator, or UPS.
Power lead—A length of electrical cable for connecting electrical equipment to a power outlet. It must have a plug attached for connection to power outlets. The other end, if not permanently wired to the equipment, has a socket (such as an IEC) for connection to another lead or a plug permanently wired into the equipment.
Power outlet—A fixture to which the power supply is connected by fixed wiring.

Socket—A female electrical connector.

Plug—A male electrical connector.

Power Connector—Either a male or female connector installed permanently in equipment.

### BACKGROUND OF INVENTION

Currently only a very few computing or network devices are available with multiple power supplies and multiple power connectors. For continuous equipment operation, managing the physical environment and power supply becomes important. In most installations, equipment is being frequently added, moved and removed. All these equipment changes require planning and co-ordination of facilities—space, access, cooling, network connections and power outlets. Major installation changes, such as installing or adding a UPS for additional reliability, requires reconnecting the power supply of most or all computing and network devices in an installation. For those few devices fitted with multiple power supplies, this is a trivial matter performed without affecting normal operation. Otherwise, equipment must be shutdown, causing service interruptions requiring careful planning, scheduling, co-ordination, and considerable extra effort.

FIG. 1 schematically illustrates the conventional manner of connecting electrical equipment to a power supply wherein a power lead 40 connects a power outlet 50 to a socket 10 in the equipment.

### SUMMARY OF INVENTION

The present invention aims to provide an alternative to known switching assemblies and methods.

In one aspect this invention resides broadly in a switching assembly for switching electrical equipment between a first electrical power supply external to the equipment and switching assembly and to which the equipment is normally connected and a second electrical power supply external to the equipment and switching assembly and to which the equipment is not normally connected, the switching assembly including:
first electrical connector means for electrical connection to electrical equipment;
second electrical connector means for electrical connection to the first electrical power supply;
third electrical connector means for electrical connection to the second electrical power supply;
switching means for switching an electrical connection between the first electrical connector means and the second electrical connector means to and from an electrical connection between the first electrical connector means and the third electrical connector means, the switching means effecting the switching substantially instantaneously.

In one preferred embodiment the first electrical connector means is a plug receivable in a socket on the electrical equipment. In this embodiment it is preferred that the second and third electrical connector means are sockets for receiving the plug of a power lead for electrically connecting the switching assembly to an electrical power supply, and that the switching means is manually operable.

In another preferred embodiment the first and second electrical connector means are the plug and socket respectively of a power lead. In this embodiment it is preferred that the third electrical connector means is a socket for receiving the plug of a power lead, and that the switching means is automatically operable upon insertion and withdrawal of a plug into the socket comprising the third electrical connector means.

In another preferred embodiment the first electrical connector means is a socket for receiving the plug of a power lead. In this embodiment the third electrical connector means is a plug for receiving the socket of a power lead, and the switching means is manually operable.

It is preferred that the switching assembly is not fixedly wired to the equipment or the power supplies.

In another aspect this invention resides broadly in a method of switching electrical equipment between a first electrical power supply external to the equipment and to which the equipment is normally connected and a second electrical power supply external to the equipment and to which the equipment is not normally connected, the method including:
connecting first electrical connector means to the electrical equipment;
connecting second electrical connector means to the first electrical power supply;
providing third electrical connector means for electrical connection to the second electrical power supply, and
operating switching means to electrically disconnect the first electrical connector means and the second electrical connector means and to electrically connect the first electrical connector means and the third electrical connector means, the switching means effecting the switching substantially instantaneously.

It will be appreciated that the switching means need not itself be external to the electrical equipment. Thus the second and third electrical connector means themselves may be located, for example with respect to the illustration in FIGS. 2 and 3, on the back face of equipment 12, with the first electrical connector means being internal and constituting the connection between an internally located switching means and the initial point of power delivery within equipment 12, such as for example an AC-DC power supply (not shown). In this aspect the invention may be regarded as residing broadly in electrical equipment including:
an internal power supply point;
first electrical connector means on the exterior of the equipment for electrical connection to a first electrical power supply to which the equipment is normally connected;
second electrical connector means on the exterior of the equipment for electrical connection to a second electrical power supply to which the equipment is not normally connected, and
switching means for switching an electrical connection between the internal power supply point and the first electrical connector means to and from an electrical connection between the internal power supply point and the second electrical connector means, the switching means effecting the switching substantially instantaneously;
whereby the electrical equipment may be switched substantially instantaneously from the first to the second electrical power supply.

In one preferred embodiment of this aspect of the invention the switching means can include a manual switch accessible from the exterior of the equipment.

Alternatively in another embodiment of this aspect of the invention, the switching means may be an electronic switch actuated electronically by a command signal generated by the equipment.

Alternatively in another embodiment of this aspect of the invention, the switching means may be automatically actuated upon failure of the first electrical power supply.

The switching means may also include a preferential automatic switch for providing power from a more preferred power source upon activation thereof.

Thus it is to be understood that references herein to the switching being substantially instantaneous, and references to the switching assembly per se, extend to embrace what may be termed automatic switching means wherein designated power sources are used preferentially. In the simplest case of two power sources, there is a primary source or electrical connection and a secondary. A simple embodiment of this arrangement is a ‘latch-up’ relay in which only if power is not available from the primary source will the alternate (and powered) source be connected. It will be realised that there has to be some ‘hysteresis’ or short settling period allowed by the switch logic when an unused but more preferred, or primary, power source becomes active. The switching is still substantially instantaneous.

The automatic switching means can switch over to power sources either (a) in a simple ‘next available active supply’ manner only on the loss of the current supply, or (b), in preferential manner between power sources, with switching initiated not only on loss of the current supply but also when more preferred supplies become active, as described above with reference to the latch-up relay.

The extension of preferential automatic switch logic to multiple power sources will be obvious to those skilled in the art.

In accordance with an alternative definition of the invention, as will be subsequently described and claimed, in one aspect the invention can be seen as residing broadly in an electrical connector assembly for alternately connecting electrical equipment between a first electrical power supply external to both the equipment and to the connector assembly and to which the equipment is normally connected, and to a second electrical power supply external to both the equipment and to the connector assembly and to which the equipment is not normally connected, such that a substantially continuous supply of power is provided to the electrical equipment, the connector assembly being separate to the electrical equipment and the power sources and being connectable thereto and disconnectable therefrom, and including:
first electrical conductor means having an electrical output means for connection to the electrical equipment;
second electrical conductor means having a first electrical input means for connection to the first electrical power supply;
third electrical conductor means having a second electrical input means for connection to the second electrical power supply;
the electrical output means outputting electrical power from the connector assembly to the electrical equipment when connected thereto, the first electrical input means inputting electrical power to the connector assembly from the first electrical power supply when connected thereto, and the second electrical input means inputting electrical power to the connector assembly from the second electrical power supply when connected thereto, and

switching means connected to the first, second and third electrical conductor means and being operable to change the power supplied to the electrical equipment from one power supply to the other while maintaining an operationally effective power supply to the equipment.

In accordance with this alternative definition of the invention, in another aspect the invention can also be seen as residing broadly in electrical equipment alternately connectable between a first electrical power supply external to the equipment and to which the equipment is normally connected, and to a second electrical power supply external to the equipment and to which the equipment is not normally connected, such that a substantially continuous supply of power is provided to the electrical equipment, the electrical equipment including:
an internal power supply point, and an electrical connector assembly including:
first electrical conductor means having an electrical output means for connection to the power supply point;
second electrical conductor means having a first electrical input means for connection to the first electrical power supply;
third electrical conductor means having a second electrical input means for connection to the second electrical power supply;
the electrical output means outputting electrical power from the connector assembly to the power supply point when connected thereto, the first electrical input means inputting electrical power to the connector assembly from the first electrical power supply when connected thereto, and the second electrical input means inputting electrical power to the connector assembly from the second electrical power supply when connected thereto, and
switching means connected to the first, second and third electrical conductor means and being operable to change the power supplied to the power supply point from one power supply to the other while maintaining an operationally effective power supply to the equipment.

### DESCRIPTION OF DRAWINGS

In order that this invention may be more easily understood and put into practical effect, reference will now be made to the accompanying drawings which illustrate a preferred embodiment of the invention, wherein:

FIG. 2 is a schematic diagram illustrating a first embodiment of the invention in normal operation;

FIG. 3 schematically illustrates the steps in the method of change electrical connection of equipment from one power outlet to another;

FIG. 4 is a wiring diagram functionally illustrating the operation of the switch in FIG. 2;

FIG. 5 is a schematic diagram illustrating a second embodiment of the invention in normal operation;

FIG. 6 is a schematic diagram illustrating a third embodiment of the invention in normal operation;

FIG. 7 is a schematic diagram illustrating an embodiment of the invention wherein the switching means is positioned within the electrical equipment and wherein a switch to actuate the switching means is positioned on the exterior of the equipment, and

FIG. 8 is a schematic diagram illustrating an alternative to the embodiment of FIG. 2 wherein the internal switching assembly is actuated electronically.

### DESCRIPTION OF PREFERRED EMBODIMENT OF INVENTION

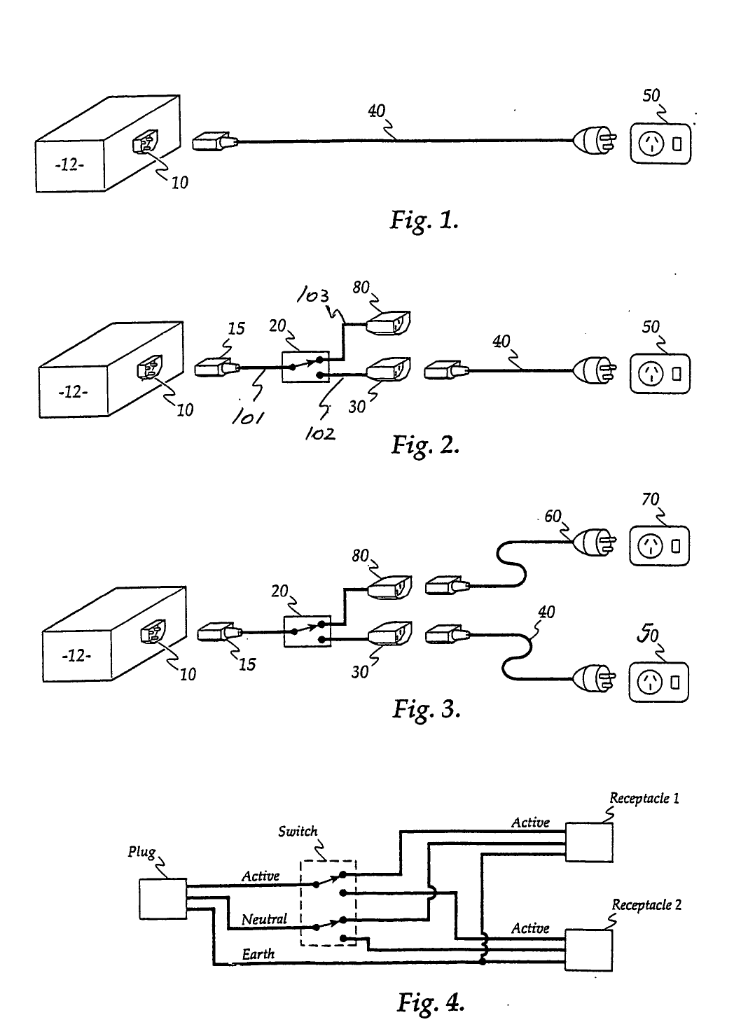

As seen in FIG. 2, plug 15 of the assembly is connected to the power socket 10 of the equipment 12. In normal operation, a power lead 40 connects a power outlet 50 to a socket 30, the switch 20 connects power from the socket 30 to the plug 15 and hence to the equipment 12.

In FIG. 3, to change-over to a different power supply (such as a new power outlet, a UPS, or a generator), an additional power lead 60 connects another power outlet 70 to an alternate socket 80. To complete the change-over, the switch 20 is thrown to connect socket 80 to the plug 15, providing power to the equipment 12. The first power lead 40 can be then removed from its socket 30.

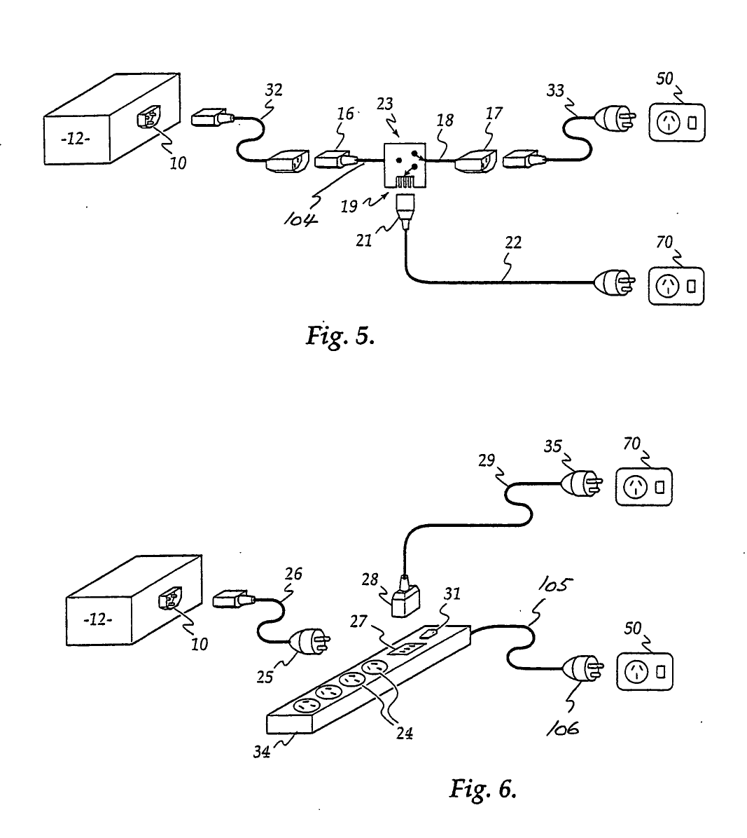

In the embodiment illustrated in FIG. 5, the switching assembly is built into a power lead 18. A power lead 32 can be connected into socket 16 for connection to equipment 12 and a second power lead 33 can be connected to plug 17 for connection to first power supply 50. A housing contains switch 23 and a socket 19 for receiving the plug connector 21 of lead 22. When plug 21 is inserted into socket 19 it operates a plunger to activate switch 23 to disconnect the existing electrical connection between socket 16 and plug 17 and to establish electrical connection between socket 16 and socket 19 whereby power supply 50 is replaced by power supply 70.

In the embodiment illustrated in FIG. 6, the switching assembly is embodied in a power distribution board or a power rack 34. Plug 25 of power lead 26 can be connected into socket 24 in power rack 34 for connection to equipment 12 for connection to a first power supply 50. Plug 28 of another power lead 29 can be connected into socket 27 in power rack 34 for connection to a second power supply 70. Power rack 34 contains switch 31 and socket 27 for receiving the plug connector 28 of lead 29. Operation of switch 31 changes connection of equipment 12 via plug 25 to socket 24 between power supply 50 and power supply 70 (via socket 27, plug 28 and lead 29).

The electrical equipment will be capable of withstanding any brief switching time, voltage change, switching transient, or phase change caused by operation of the switch and so in practice the device of the present invention should not be used on equipment sensitive to such minor power supply variations.

The assembly is preferably configured for single phase AC operation and the design of a three phase or DC version will be obvious to persons skilled in the art.

It will be appreciated that specific design will be required to comply to local standards, registration or safety authority requirements.

For all unit types (DC or AC single or three phase), the ‘Earth’ lead of the plug and all sockets can be directly connected or switched. All other leads must be individually switched for electrical safety and avoiding hazards when switching between either independent power generators or different phases on the same generator. For DC or AC single phase, this requires a ‘double pole double throw’ switch as seen in FIG. 4 for the two other leads (normally termed ‘active’ and ‘neutral’). The switch must be of the ‘break before make’ type.

In a preferred embodiment the power change-over assembly comprises all components in a single or moulded assembly.

Thus it will be realised that in all preferred embodiments described above the switching assembly of the present invention includes first electrical connector means 15 for electrical connection to electrical equipment 12, second electrical connector means 30 for electrical connection to a first electrical power supply 50, third electrical connector means 80 for electrical connection to a second electrical power supply 70, and switching means 20 for switching an electrical connection between the first electrical connector means 15 and the second electrical connector means 30 to and from an electrical connection between the first electrical connector means 15 and the third electrical connector means 80.

In the embodiment illustrated in FIGS. 2 and 3, the first electrical connector means 15 is a plug receivable in a socket 10 on the electrical equipment 12. In this embodiment it is preferred that the second and third electrical connector means 30,80 are sockets for receiving the plugs of power lead 40,60 for electrically connecting the switching assembly to electrical power supplies 50,70 and that the switching means 20 is manually operable.

In the embodiment illustrated in FIG. 5, the first and second electrical connector means are the plug 16 and socket 17 respectively of a power lead 18. In this embodiment it is preferred that the third electrical connector means is a socket 19 for receiving the plug 21 of a power lead 22, and that the switching means 23 is operable upon insertion and withdrawal of plug 21 into socket 19 which comprises the third electrical connector means, to switch an electrical connection between plug 16 and socket 17 to an electrical connection between plug 16 and socket 19.

In the embodiment illustrated in FIG. 6, the first electrical connector means is a socket 24 for receiving the plug 25 of a power lead 26 and the second electrical connector means is plug 35 for connection to power supply 50. In this embodiment the third electrical connector means is a plug 27 for receiving the socket 28 of a power lead 29. Switching means 31 is manually operable to switch an electrical connection between socket 24 and plug 35 to an electrical connection between socket 24 and plug 27.

It will also be appreciated that in use the method of the present invention switches electrical equipment between power supplies 50 and 70 by connecting first electrical connector means 15 to electrical equipment 12, by connecting second electrical connector means 30 to the first electrical power supply 50, by providing third electrical connector means 80 for electrical connection to the second electrical power supply 70, and by operating switching means 20 to electrically disconnect the first electrical connector means 15 and the second electrical connector means 30 and to electrically connect the first electrical connector means 20 and the third electrical connector means 80; the first, second and third electrical connector means 15, 30, 80 and the switching means 20 being included in a switching assembly.

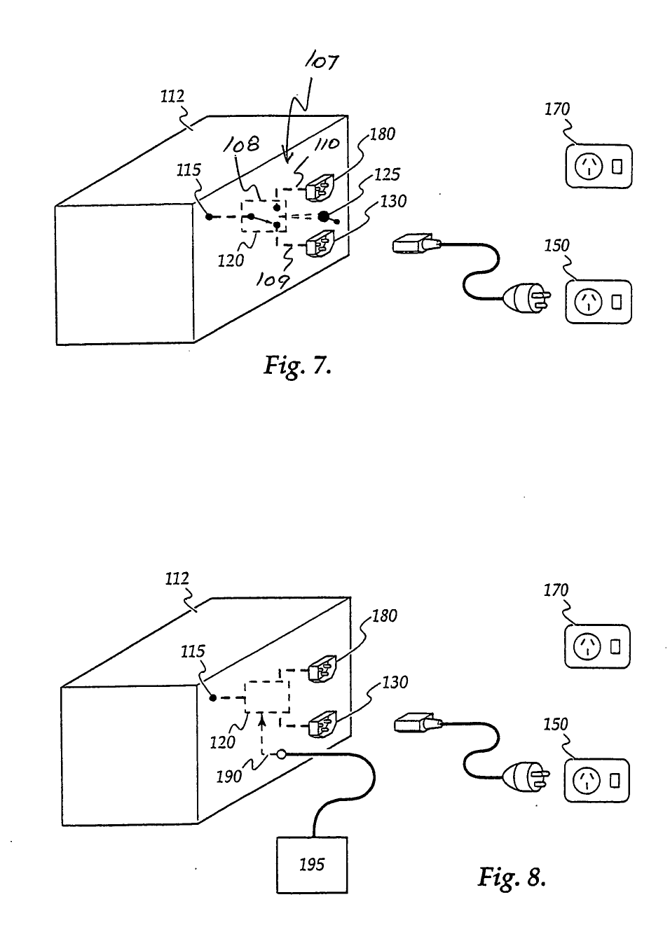

FIGS. 7 and 8 illustrate embodiments of the invention wherein the switching assembly is internal of the electrical equipment with dual connectors on the exterior thereof.

As seen in FIG. 7, electrical equipment 112 has an internal power supply point 115 which is connected to an internal switching assembly 120. A first electrical connector 130 is located on the exterior of equipment 112 for electrical connection to a first electrical power supply 150 to which equipment 112 is normally connected. A second electrical connector 180 is located on the exterior of equipment 1 12 for electrical connection to a second electrical power supply 170 to which equipment 112 is not normally connected. Switching means 120 is actuated by a manual switch 125 accessible from the exterior of equipment 112 and effects substantially instantaneous switching from electrical connection between internal power supply point 115 and first electrical connector 130 to and from electrical connection between internal power supply point 115 and second electrical connector 180. Consequently electrical equipment 112 may be switched substantially instantaneously from the first electrical power supply 150 to the second electrical power supply 170.

As seen in FIG. 8, electrical equipment 112 has an internal power supply point 115 which is connected to an internal switching assembly 120. A first electrical connector 130 is located on the exterior of equipment 112 for electrical connection to a first electrical power supply 150 to which equipment 112 is normally connected. A second electrical connector 180 is located on the exterior of equipment 112 for electrical connection to a second electrical power supply 170 to which equipment 112 is not normally connected. Electronic switching means 190 is actuated by a command entered on the equipment, for example via keyboard 195 where equipment 112 is a computer. Actuation effects substantially instantaneous electronic switching from electrical connection between internal power supply point 115 and first electrical connector 130 to and from electrical connection between internal power supply point 115 and second electrical connector 180. Consequently electrical equipment 112 may be switched substantially instantaneously from the first electrical power supply 150 to the second electrical power supply 170.

As referred to previously and as seen in both FIGS. 7 and 8, the switching means may be automatic, possibly preferential to a given power source, and may not require any external switches or connections.

With reference to the alternative definition of the invention referred to in the summary of the invention, and as subsequently claimed, the invention as illustrated in FIGS. 2 and 3 may be described as an electrical connector assembly for alternately connecting electrical equipment 12 between a first electrical power supply 50 external to both the equipment 12 and to the connector assembly and to which the equipment 12 is normally connected, and to a second electrical power supply 70 external to both the equipment 12 and to the connector assembly and to which the equipment 12 is not normally connected, such that a substantially continuous supply of power is provided to the electrical equipment 12, the connector assembly being separate to the electrical equipment 12 and the power sources 50, 70 and being connectable thereto and disconnectable therefrom. The electrical connector assembly includes
first electrical conductor means 101 having an electrical output means 15 for connection to the electrical equipment 12;
second electrical conductor means 102 having a first electrical input means 30 for connection to the first electrical power supply 50;
third electrical conductor means 103 having a second electrical input means 80 for connection to the second electrical power supply 70;
the electrical output means 15 outputting electrical power from the connector assembly to the electrical equipment 12 when connected thereto, the first electrical input means 30 inputting electrical power to the connector assembly from the first electrical power supply 50 when connected thereto, and the second electrical input means 80 inputting electrical power to the connector assembly from the second electrical power supply 70 when connected thereto, and
switching means 20 connected to the first, second and third electrical conductor means and being operable to change the power supplied to the electrical equipment 12 from one power supply to the other while maintaining an operationally effective power supply to the equipment.

With further reference to this alternative definition of the invention, the invention as illustrated in FIG. 5 may be described as an electrical connector assembly for alternately connecting electrical equipment 12 between a first electrical power supply 50 external to both the equipment 12 and to the connector assembly and to which the equipment 12 is normally connected, and to a second electrical power supply 70 external to both the equipment 12 and to the connector assembly and to which the equipment 12 is not normally connected, such that a substantially continuous supply of power is provided to the electrical equipment 12, the connector assembly being separate to the electrical equipment 12 and the power sources 50, 70 and being connectable thereto and disconnectable therefrom. The electrical connector assembly includes:
first electrical conductor means 104 having an electrical output means 16 for connection to the electrical equipment 12;
second electrical conductor means 18 having a first electrical input means 17 for connection to the first electrical power supply 50;
third electrical conductor means (not illustrated) having a second electrical input means 19 for connection to the second electrical power supply 70;
the electrical output means 16 outputting electrical power from the connector assembly to the electrical equipment 12 when connected thereto, the first electrical input means 17 inputting electrical power to the connector assembly from the first electrical power supply 50 when connected thereto, and the second electrical input means 19 inputting electrical power to the connector assembly from the second electrical power supply 70 when connected thereto, and
switching means 23 conriected to the first, second and third electrical conductor means and being operable to change the power supplied to the electrical equipment 12 from one power supply to the other while maintaining an operationally effective power supply to the equipment.

Again with reference to this altenative definition of the invention, the invention as illustrated in FIG. 6 may be described as an electrical connector assembly for alternately connecting electrical equipment 12 between a first electrical power supply 50 external to both the equipment 12 and to the connector assembly and to which the equipment 12 is normally connected, and to a second electrical power supply 70 external to both the equipment 12 and to the connector assembly and to which the equipment 12 is not normally connected, such that a substantially continuous supply of power is provided to the electrical equipment 12, the connector assembly being separate to the electrical equipment 12 and the power sources 50, 70 and being connectable thereto and disconnectable therefrom. The electrical connector assembly includes
first electrical conductor means (not illustrated) having an electrical output means 24 for connection to the electrical equipment 12;
second electrical conductor means 105 having a first electrical input means 106 for connection to the first electrical power supply 50;
third electrical conductor means (not illustrated) having a second electrical input means 27 for connection to the second electrical power supply 70;
the electrical output means 24 outputting electrical power from the connector assembly to the electrical equipment 12 when connected thereto, the first electrical input means 106 inputting electrical power to the connector assembly from the first electrical power supply 50 when connected thereto, and the second electrical input means 27 inputting electrical power to the connector assembly from the second electrical power supply 70 when connected thereto, and
switching means 31 connected to the first, second and third electrical conductor means and being operable to change the power supplied to the electrical equipment 12 from one power supply to the other while maintaining an operationally effective power supply to the equipment.

With further reference to this alternative definition of the invention, the invention as illustrated in FIGS. 7 and 8 may be described as electrical equipment 112 alternately connectable between a first electrical power supply 150 external to the equipment and to which the equipment is normally connected, and to a second electrical power supply 170 external to the equipment and to which the equipment is not normally connected, such that a substantially continuous supply of power is provided to the electrical equipment, the electrical equipment including:
an internal power supply point 115, and an electrical connector assembly 107 including:
first electrical conductor means 108 having an electrical output means (not illustrated) for connection to the power supply point 115;
second electrical conductor means 109 having a first electrical input means 130 for connection to the first electrical power supply 150;
third electrical conductor means 110 having a second electrical input means 180 for connection to the second electrical power supply 170;
the electrical output means outputting electrical power from the connector assembly 107 to the power supply point 115 when connected thereto, the first electrical input means 130 inputting electrical power to the connector assembly 107 from the first electrical power supply 150 when connected thereto, and the second electrical input means 180 inputting electrical power to the connector assembly 107 from the second electrical power supply 170 when connected thereto, and
switching means (120,125 in FIG. 7; 120,190,195 in FIG. 8) connected to the first, second and third electrical conductor means and being operable to change the power supplied to the power supply point 115 from one power supply to the other while maintaining an operationally effective power supply to the equipment.
It will be understood that several features of the various preferred embodiments of switching assembly can readily be varied without departing from the spirit or scope of the invention. These include, by way of non-exhaustive example, the type, orientation or polarisation of the connectors; the position or number and type of switches; whether switching is manual or automatic, and if automatic, whether operation is activated by insertion of a plug in a socket, or by automatic switching upon loss of existing power; the provision of electronic switching; the number of power sockets; the ability to swivel, rotate or move the plug and sockets in relation to each other; whether there are indicators or lights, fuses or similar safety devices, and safety shutters or interlocks; the length or type of any external power lead connecting parts of the assembly; or any requirements incurred by local registration or standards authorities.

It will also be appreciated that the sockets can include a spring loaded flap or cover over the normally unused or disconnected socket thereby indicating useability as well as preventing the ingress of dust and contamination.

It will also be readily appreciated that although sockets and leads are illustrated, these could be replaced by hard wired connections without departing from the spirit and scope of the invention. Thus the invention contemplates a “power change-over unit’ for domestic appliances such as refrigerators which are always turned on.

In its various embodiments it will be appreciated that the present invention has a number of advantages over known switching assemblies and methods and provides simple method to allow the change-over of power supply to (computer and network) equipment without disrupting normal, continuous operation. The assembly/device of the present invention can be regarded as being in the nature of a “reverse double adaptor”.

Other advantages include the following:

The present invention does not involve or require a fixed installation.

The present invention, in the external embodiment) is not part of the equipment per se and does not require the provision of battery backup power.

The present invention, not being a UPS, avoids the cost and complexities associated with these.

Electrical equipment, such as computers and network devices can continue to function normally whilst they are connected to a different source of electrical power.

The present invention allows for quick, simple connection of electrical equipment to an alternate power outlet.

The present invention is supplied as a complete operating unit with no specialist installation or safety requirements. Operation of the unit requires no additional safety steps or training and is performed by non specialist staff.

The present invention allows electronic equipment, such as computers or network devices, to operate normally during a change of power source without affecting normal operation.

Whilst some computers or network devices may be supplied with redundant, even removable power supplies, often the manufacturers provide only one power socket hence requiring the equipment to be shutdown to change power outlets, or having the equipment fail outright on the loss of the single supply, even if an altenative supply has been provided.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. A switching assembly for switching electrical equipment between a first electrical power supply external to the equipment and switching assembly and to which the equipment is normally connected and a second electrical power supply external to the equipment and switching assembly and to which the equipment is not normally connected, the switching assembly including:
first electrical connector means for electrical connection to electrical equipment;
second electrical connector means for electrical connection to the first electrical power supply;
third electrical connector means for electrical connection to the second electrical power supply, and
switching means for switching an electrical connection between the first electrical connector means and the second electrical connector means to and from an electrical connection between the first electrical connector means and the third electrical connector means, the switching means effecting the switching substantially instantaneously.

2. A switching assembly as claimed in claim 1, wherein the first electrical connector means is a plug receivable in a socket on the electrical equipment.

3. A switching assembly as claimed in claim 2, wherein the second and third electrical connector means are sockets for receiving the plug of a power lead for electrically connecting the switching assembly to an electrical power supply.

4. A switching assembly as claimed in claim 3, wherein the switching means is manually operable.

5. A switching assembly as claimed in claim 1, wherein the first and second electrical connector means are the plug and socket respectively of a power lead.

6. A switching assembly as claimed in claim 5, wherein the third electrical connector means is a socket for receiving the plug of a power lead.

7. A switching assembly as claimed in claim 6, wherein the switching means is automatically operable upon insertion and withdrawal of a plug into the socket comprising the third electrical connector means.

8. A switching assembly as claimed in claim 1, wherein the first electrical connector means is a socket for receiving the plug of a power lead.

9. A switching assembly as claimed in claim 8, wherein the third electrical connector means is a plug for receiving the socket of a power lead.

10. A switching assembly as claimed in claim 9, wherein the switching means is manually operable.

11. A switching assembly as claimed in claim 1, wherein the switching assembly is not fixedly wired to the equipment or the power supplies.

12. A method of switching electrical equipment between a first electrical power supply external to the equipment and to which the equipment is normally connected and a second electrical power supply external to the equipment and to which the equipment is not normally connected, the method including:
connecting first electrical connector means to the electrical equipment;
connecting second electrical connector means to the first electrical power supply;
providing third electrical connector means for electrical connection to the second electrical power supply, and
operating switching means to electrically disconnect the first electrical connector means and the second electrical connector means and to electrically connect the first electrical connector means and the third electrical connector means, the switching means effecting the switching substantially instantaneously.

13. Electrical equipment including:
an internal power supply point;
first electrical connector means on the exterior of the equipment for electrical connection to a first electrical power supply to which the equipment is normally connected;
second electrical connector means on the exterior of the equipment for electrical connection to a second electrical power supply to which the equipment is not normally connected, and
switching means for switching an electrical connection between the internal power supply point and the first electrical connector means to and from an electrical connection between the internal power supply point and the second electrical connector means, the switching means effecting the switching substantially instantaneously;
whereby the electrical equipment may be switched substantially instantaneously from the first to the second electrical power supply.

14. Electrical equipment as claimed in claim 13, wherein the switching means includes a manual switch accessible from the exterior of the equipment.

15. Electrical equipment as claimed in claim 13, wherein the switching means includes an electronic switch actuated electronically by a command signal generated by the equipment.

16. Electrical equipment as claimed in claim 13, wherein the switching means is automatically actuated upon failure of the first electrical power supply.

17. Electrical equipment as claimed in claim 13, wherein the switching means includes a preferential automatic switch for providing power from a more preferred power source upon activation thereof.

18. An electrical connector assembly for alternately connecting electrical equipment between a first electrical power supply external to both the equipment and to the connector assembly and to which the equipment is normally connected, and to a second electrical power supply external to both the equipment and to the connector assembly and to which the equipment is not normally connected, such that a substantially continuous supply of power is provided to the electrical equipment, the connector assembly being separate to the electrical equipment and the power sources and being connectable thereto and disconnectable therefrom, and including:
first electrical conductor means having ari electrical output means for connection to the electrical equipment;
second electrical conductor means having a first electrical input means for connection to the first electrical power supply;
third electrical conductor means having a second electrical input means for connection to the second electrical power supply;
the electrical output means outputting electrical power from the connector assembly to the electrical equipment when connected thereto, the first electrical input means inputting electrical power to the connector assembly from the first electrical power supply when connected thereto, and the second electrical input means inputting electrical power to the connector assembly from the second electrical power supply when connected thereto, and
switching means connected to the first, second and third electrical conductor means and being operable to change the power supplied to the electrical equipment from one power supply to the other while maintaining an operationally effective power supply to the equipment.

19. Electrical equipment alternately connectable between a first electrical power supply external to the equipment and to which the equipment is normally connected, and to a second electrical power supply external to the equipment and to which the equipment is not normally connected, such that a substantially continuous supply of power is provided to the electrical equipment, the electrical equipment including:
an internal power supply point, and an electrical connector assembly including:
first electrical conductor means having an electrical output means for connection to the power supply point;
second electrical conductor means having a first electrical input means for connection to the first electrical power supply;
third electrical conductor means having a second electrical input means for connection to the second electrical power supply;
the electrical output means outputting electrical power from the connector assembly to the power supply point when connected thereto, the first electrical input means inputting electrical power to the connector assembly from the first electrical power supply when connected thereto, and the second electrical input means inputting electrical power to the connector assembly from the second electrical power supply when connected thereto, and
switching means connected to the first, second and third electrical conductor means and being operable to change the power supplied to the power supply point from one power supply to the other while maintaining an operationally effective power supply to the equipment.
